(19) United States
(12) Patent Application Publication
(10) Pub. No.: US 2008/0304660 A1
(43) Pub. Date: Dec. 11, 2008

(54) IMAGE FORMING APPARATUS ALLOWING EASY MANAGEMENT RELATING TO USER'S USAGE

(75) Inventors: Kazumi SAWAYANAGI, Itami-shi (JP); Hironobu Nakata, Itami-shi (JP); Hiroyuki Kawabata, Kawanishi-shi (JP); Toshihiko Otake, Ikeda-shi (JP); Yoshiki Tokimoto, Nishiwaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/115,314

(22) Filed: May 5, 2008

(30) Foreign Application Priority Data
Jun. 11, 2007 (JP) 2007-154356

(51) Int. Cl. H04L 9/32; G06F 17/00

(52) U.S. Cl. 380/44; 713/185

(57) ABSTRACT

An MFP 1 reads file information and directory information from a mounted medium to calculate a hash value, and encrypts the hash value and a user name of a user logged thereinto to create an authentication key. The authentication key and network information of the MFP 1 are written to the medium, and the hash value is retained in MFP 1 in association with the user name. An MFP 2 reads the above-described information from the mounted medium, and transmits to the MFP 1 the authentication key and a hash value calculated from the file information and the directory information of the medium, to thereby request authentication. Based on a user name obtained by decoding the authentication key, the MFP 1 compares the hash value retained in association with the user name and the hash value transmitted from the MFP 2, and authenticates the user's usage of the MFP 2.

This application is based on Japanese Patent Application No. 2007-154356 filed with the Japan Patent Office on Jun. 11, 2007, the entire content of which is hereby incorporated by reference.

### BACKGROUND OF THE INVENTION

1. Field of the Invention

The present invention relates to an image forming apparatus, a method of managing usage and a usage amount in the image forming apparatuses, and a computer readable recording medium recording a management program. The present invention particularly relates to an image forming apparatus having a medium attachable thereto and removable therefrom, a method of managing usage and a usage amount in each of the image forming apparatuses, and a computer readable recording medium recording a management program for managing usage and a usage amount in each of the image forming apparatuses.

2. Description of the Related Art

In the case where an image forming apparatus such as a Multi Function Peripheral (MFP) placed in an office environment is shared for use by a plurality of users, there is often adopted a method of registering in advance with the image forming apparatus and managing users permitted to use the image forming apparatus, as well as functions, a number of sheets to be printed (a number of sheets to be used) and others each of the users is permitted to use. By doing so, it is possible to permit only a user successfully authenticated to use the image forming apparatus, or to manage a count such as a number of sheets used by the relevant user.

As a method of managing usage and a usage amount in such an image forming apparatus in a usage state where a medium such as Universal Serial Bus (USB) memory is mounted thereon to output information in the medium or write scanned image data to the medium, Japanese Laid-Open Patent Publication No. 2006-092115 (hereinafter referred to as Patent Document 1) discloses a method of transmitting data to be printed to an MFP, and at the same time, automatically generating confidential printing control data including a password and storing the same in the USB memory, and specifying the transmitted data based on the stored data when the USB is mounted on the MFP.

However, assume the case where the above-described management is adopted in an image forming apparatus, and that a user intends to use an image forming apparatus such as an MFP in another place, with which the user is not registered. Even if a medium to be used stores the above-described control data, there is required an operation such as registering the user with the relevant image forming apparatus and setting limiting information appropriate to the relevant user, if desired. Accordingly, there arises a problem of poor usability.

Furthermore, if a user registered himself/herself with an image forming apparatus as described above to use the relevant image forming apparatus, information relating to management of the relevant user, such as a counter indicative of a number of used sheets, is not associated with information relating to management in an image forming apparatus usually used by the relevant user. Accordingly, in the case where a user's usage of an image forming apparatus is under collective management by a server or the like, for example, and if an image forming apparatus not under the management is used, there also arises a problem of failure in appropriate management thereof.

### SUMMARY OF THE INVENTION

The present invention has been made in view of these problems. An object of the present invention is to provide an image forming apparatus allowing easy management relating to a user's usage without requiring any complicated operation, a method of managing usage and a usage amount in each of the image forming apparatuses, and a computer readable recording medium recording a management program for managing usage and a usage amount in each of the image forming apparatuses.

To achieve the above-described object, according to an aspect of the present invention, an image forming apparatus includes: a user information obtaining unit obtaining user information of a user logging into the image forming apparatus; a retaining unit retaining information specific to a mounted medium in association with the user information; a creation unit creating a first authentication key by encrypting the user information; a write unit writing to the medium the first authentication key and information for specifying the image forming apparatus; an authentication information obtaining unit obtaining authentication information from another image forming apparatus; a decode unit decoding a second authentication key included in the authentication information; a comparison unit making comparison, based on user information obtained by decoding the second authentication key, between the information specific to the medium and retained by the retaining unit in association with the user information obtained by decoding the second authentication key, and information specific to a medium and included in the authentication information; and an output unit outputting a result of the comparison to the other image forming apparatus.

According to another aspect of the present invention, an image forming apparatus includes: a read unit reading information for specifying another image forming apparatus and an authentication key from a mounted medium; a request unit requesting authentication from the other specified image forming apparatus by transmitting thereto information specific to the medium and the authentication key, as authentication information; an authentication result obtaining unit obtaining a result of the authentication from the other image forming apparatus; and a presentation unit presenting a specific function in a selectable manner, based on information included in the result of the authentication.

According to still another aspect of the present invention, a method of managing usage and a usage amount in each of image forming apparatuses is a method of managing usage and a usage amount by a user in each of a first image forming apparatus and a second image forming apparatus, and includes the steps of: obtaining user information of the user logging into the first image forming apparatus, in the first image forming apparatus; retaining information specific to a medium mounted on the first image forming apparatus, in the first image forming apparatus in association with the user information; creating an authentication key by encrypting the user information in the first image forming apparatus; writing the authentication key and information for specifying the first image forming apparatus to the medium in the first image forming apparatus; reading the authentication key and the information for specifying the first image forming apparatus from the medium mounted on the second image forming apparatus, in the second image forming apparatus; requesting authentication from the first image forming apparatus by transmitting thereto the information specific to the medium mounted on the second image forming apparatus and the authentication key, as authentication information, in the second image forming apparatus; decoding the authentication key transmitted from the second image forming apparatus, in the first image forming apparatus; making a comparison in the first image forming apparatus, based on user information obtained by decoding the authentication key, between the information specific to the medium and retained in association with the user information obtained by decoding the authentication key, and information specific to the medium and included in the authentication information; outputting a result of the comparison as a result of the authentication from the first image forming apparatus to the second image forming apparatus; and presenting a specific function in a selectable manner in the second image forming apparatus, based on information included in the result of the authentication from the first image forming apparatus.

According to a further aspect of the present invention, a computer readable recording medium recording a management program records a management program for allowing a computer to manage usage and a usage amount by a user in each of a first image forming apparatus and a second image forming apparatus, and the management program allows the computer to execute the steps of: obtaining user information of the user logging into the first image forming apparatus, in the first image forming apparatus; retaining information specific to a medium mounted on the first image forming apparatus, in the first image forming apparatus in association with the user information; creating an authentication key by encrypting the user information in the first image forming apparatus; writing the authentication key and information for specifying the first image forming apparatus to the medium in the first image forming apparatus; reading the authentication key and the information for specifying the first image forming apparatus from the medium mounted on the second image forming apparatus, in the second image forming apparatus; requesting authentication from the first image forming apparatus by transmitting thereto the information specific to the medium mounted on the second image forming apparatus and the authentication key, as authentication information, in the second image forming apparatus; decoding the authentication key transmitted from the second image forming apparatus, in the first image forming apparatus; making a comparison in the first image forming apparatus, based on user information obtained by decoding the authentication key, between the information specific to the medium and retained in association with the user information obtained by decoding the authentication key, and information specific to the medium and included in the authentication information; outputting a result of the comparison as a result of the authentication from the first image forming apparatus to the second image forming apparatus; and presenting a specific function in a selectable manner in the second image forming apparatus, based on information included in the result of the authentication from the first image forming apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a practical example of a hardware configuration of MFPs 1 and 2.

FIG. 2 is a block diagram showing a practical example of a functional configuration of MFP 1 for managing a user's usage of an MFP.

FIG. 3 is a block diagram showing a detailed practical example of a configuration included in a creation unit 109.

FIG. 4 is a flowchart showing a process of creating an authentication key in MFP 1.

FIGS. 5A-5E are drawings each of which shows an example of a screen in the process of creating the authentication key in MFP 1.

FIG. 6 is a block diagram showing a practical example of a functional configuration of MFP 2 for managing a user's usage of an MFP.

FIG. 7 is a flowchart showing a process of managing a user's usage of an MFP in MFP 2.

FIG. 8 is a flowchart showing a practical example of an authentication process in which MFP 2 requests the authentication process from MFP 1 identified as a transmission destination and receives a result thereof in step S207.

FIGS. 9A-9E are drawings each of which shows an example of a screen in the process of managing a user's usage of an MFP in MFP 2.

FIG. 10 is a block diagram showing a detailed practical example of a configuration included in an authentication unit 117.

FIG. 11 is a flowchart showing a practical example of an authentication process in MFP 1.

FIG. 12 is a drawing for describing a flow of the process of managing a user's usage in MFP 1 and MFP 2.

### DESCRIPTION OF THE PREFERRED EMBODIMENTS

An embodiment of the present invention will hereinafter be described with reference to the drawings. In the following description, the same parts and components have the same reference characters attached thereto, and have the same names and functions as well.

An image forming apparatus according to the present invention corresponds to a copy machine, a printer, a Multi Function Peripheral (MFP) identified as a complex device thereof, or the like, on which an attachable and removable recording medium (hereinafter referred to as “medium”) such as Universal Serial Bus (USB) memory can be mounted. In the present embodiment, an image forming apparatus is an MFP. In the following description, an MFP 1 is an MFP with which a user is registered, while an MFP 2 is an MFP with which the user is not registered, and MFP 1 and MFP 2 are connected to each other in a wired or wireless manner. MFPs 1, 2 have the same hardware configuration.

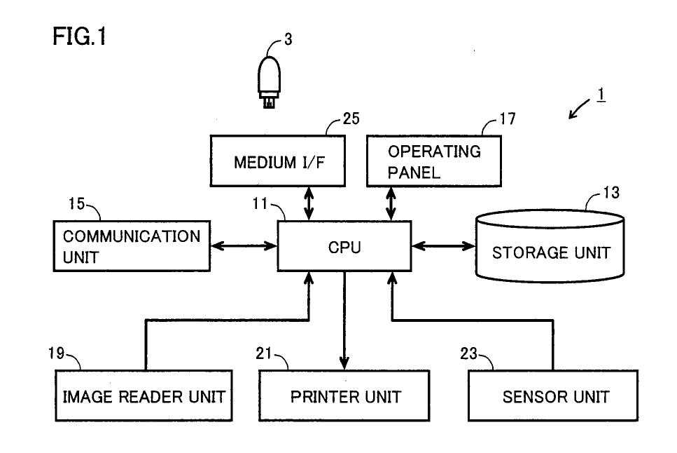

With reference to FIG. 1, MFP 1 is configured to include a Central Processing Unit (CPU) 11 controlling the entire apparatus, an image reader unit 19 reading image data from an original, a printer unit 21 printing an image on a sheet, a communication unit 15 for connecting MFP 1 to the Internet or establishing short-distance wireless communication, a storage unit 13 configured with a Hard Disk (HD), Random Access Memory (RAM), or the like, for storing a job, a program executed in CPU 11, or the like, an operating panel 17 serving as an interface with a user, a sensor unit 23 detecting a remaining amount of a consumable article, or the like, and a medium interface (hereinafter referred to as a medium I/F) 25 serving as an interface for allowing a medium 3 to be mounted thereon to read information stored in medium 3 or write information to medium 3. MFP 2 has the same hardware configuration as that shown in FIG. 1.

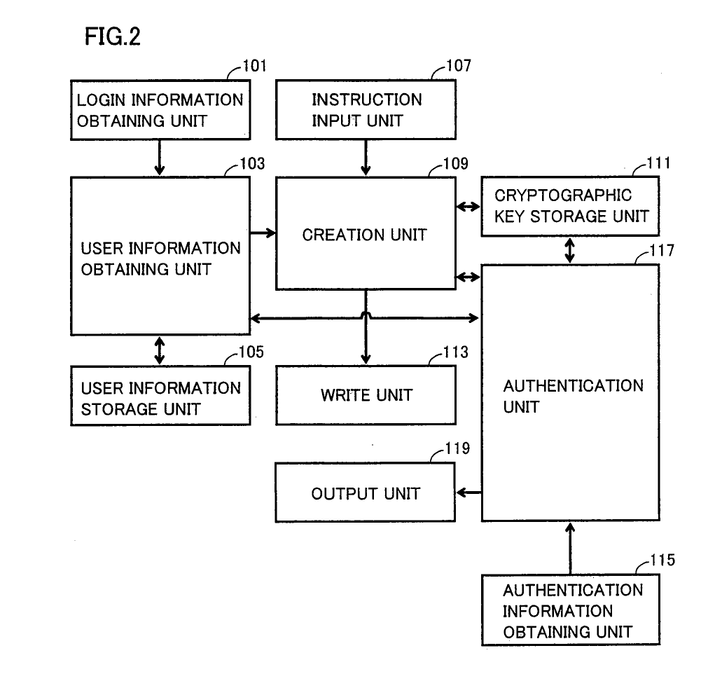

With reference to FIG. 2, functions of MFP 1 for managing a user's usage of an MFP are configured to include a login information obtaining unit 101, a user information obtaining unit 103, a user information storage unit 105, an instruction input unit 107, a creation unit 109, a write unit 113, a cryptographic key storage unit 111, an authentication information obtaining unit 115, an authentication unit 117, and an output unit 119. Each of the functions shown in FIG. 2 is implemented mainly by CPU 11 in MFP 1 executing a program stored in storage unit 13. However, a part of the functions may be configured with hardware.

User information storage unit 105 corresponds to a prescribed region in storage unit 13, and stores user information for each user. The user information includes information for identifying the relevant user, login information identified as authentication information for login, information for managing the relevant user's usage of MFP 1, and the like. In the present embodiment, the information for identifying a user is specifically a user name. However, other information may be used as long as it is information with which the user can be identified. In the present embodiment, the login information is specifically a password. However, other information may be used as long as it is information that can be used for an authentication process. Furthermore, the login information may include the information for identifying the user. The information for managing the relevant user's usage of MFP 1 specifically corresponds to information indicating to the relevant user permission/non-permission to use a function of MFP 1, information for limiting usage such as limited number of sheets or usage authorization, and the like. In the following description, information corresponding to a user and relating to a function the relevant user is permitted to use, information corresponding to a user for limiting usage of the function, and the like are referred to as “permitted function information” of the relevant user.

Cryptographic key storage unit 111 corresponds to a prescribed region in storage unit 13, and stores a public key identified as a cryptographic key specific to MFP 1 and made public on a network, and a private key not made public on the network. The public key is stored in the prescribed region described above in a region accessible by a user operation, and can be obtained by a user operation. The private key is stored in the prescribed region described above in a region, access to which is not permitted by a user operation, and can be obtained not by a user operation, but by a decoding process in MFP 1, which will be described below. Practical forms of the public key and the private key are not limited in the present invention, and any key may be used as long as it is used in a known encryption and decoding technique.

Login information obtaining unit 101 obtains login information from an operation signal based on a user's login operation, by displaying a login screen on operating panel 17, or the like. The obtained login information is passed to user information obtaining unit 103. User information obtaining unit 103 searches user information storage unit 105 based on the login information, and obtains user information of the relevant user.

When instruction input unit 107 receives a user operation for creating an authentication key described below with the use of operating panel 17, it inputs to creation unit 109 an operation signal indicating the user operation for creating an authentication key. Creation unit 109 creates an authentication key in accordance with the operation signal. At that time, creation unit 109 obtains user information of the relevant user from user information obtaining unit 103 and obtains a public key from cryptographic key storage unit 111, to use them to create the authentication key. The created authentication key is written to medium 3 mounted on MFP 1, by write unit 113.

Authentication information obtaining unit 115 obtains authentication information, which will be described below, transmitted from MFP 2 serving as an authenticated side that requests authentication, and passes it to authentication unit 117. Authentication unit 117 executes an authentication process, which will be described below, based on the authentication information. At that time, authentication unit 117 obtains user information of the relevant user from user information obtaining unit 103, obtains a private key from cryptographic key storage unit 111, and obtains a hash value, which will be described below, retained in creation unit 109, for using them in the authentication process. If a result of the authentication and the authentication are successful, necessary information is output from output unit 119 to MFP 2. Details of authentication unit 117 will be described below.

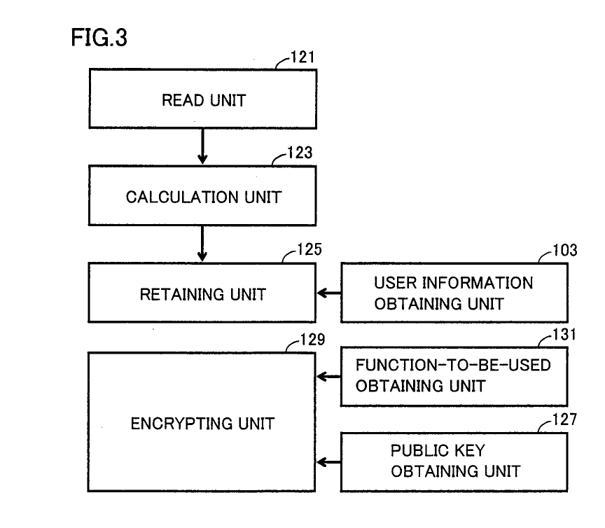

With reference to FIG. 3, creation unit 109 is configured to include a read unit 121, a calculation unit 123, a retaining unit 125, a public key obtaining unit 127, an encrypting unit 129, and a function-to-be-used obtaining unit 131.

When an authentication key is to be made, read unit 121 reads prescribed information from medium 3 mounted on MFP 1 and inputs it to calculation unit 123. Calculation unit 123 calculates information specific to medium 3 from the prescribed information of medium 3. Retaining unit 125 retains the calculated specific information in association with the user information obtained by user information obtaining unit 103. In the present practical example, the prescribed information read from medium 3 is file information identified as information of a file, such as a file name stored in medium 3, and directory information identified as information indicating a directory name, a directory configuration, or the like created in medium 3. Calculation unit 123 calculates a hash value identified as the information specific to medium 3 from these pieces of information. The prescribed information read from medium 3 is not limited to the file information and the directory information, and may be at least one of them. Furthermore, the information specific to medium 3 is not limited to the hash value calculated from the file information and the directory information. A serial number, an identifier, or the like may directly be used therefor without calculation by calculation unit 123. Alternatively, there may be used a value uniquely calculated by calculation unit 123 from other information stored in medium 3.

Public key obtaining unit 127 obtains a public key from cryptographic key storage unit 111 and inputs it to encrypting unit 129. Function-to-be-used obtaining unit 131 obtains a function selected as a function to be used by a user in MFP 2, from the operation signal received from operating panel 17, and inputs to encrypting unit 129 a signal indicative of obtainment of the function. In the following description, information indicating a function selected as a function to be used by a user in MFP 2 is referred to as function-to-be-used information. Encrypting unit 129 encrypts a user name included in the user information obtained by user information obtaining unit 103 and the input function-to-be-used information by using the public key, to thereby create an authentication key. The user name included in the authentication key may be any information as long as it is information with which the relevant user can be specified in MFP 1. Instead of the user name, there may also be used a password, an identification number, or the like with which the relevant user can be specified. Alternatively, the user information itself may be used.

Write unit 113 writes to medium 3 the created authentication key, along with the information for specifying MFP 1 stored in the prescribed region in storage unit 13. The information for specifying MFP 1 may be any information that enables access to MFP 1. In the following description, the information for specifying MFP 1 is network information (e.g. an IP address or the like) identified as access information. As another practical example, the information for specifying MFP 1 may be a machine name with which MFP 1 can uniquely be specified on the network.

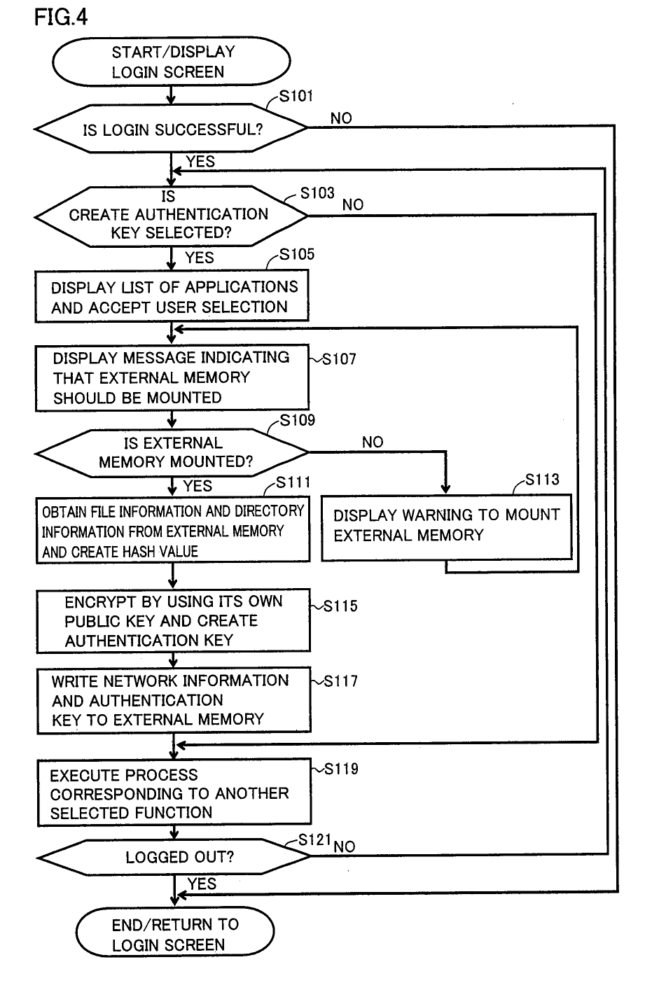

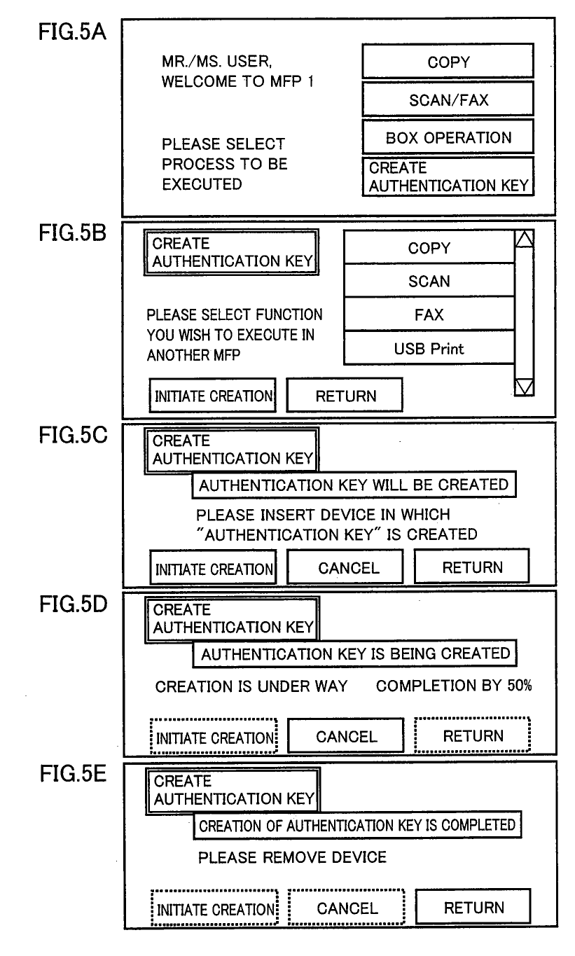

A process of creating an authentication key in MFP 1 as shown in a flowchart in FIG. 4 is the one initiated when MFP 1 is turned on to display a login screen, and a user's login operation is accepted. The process is implemented by CPU 11 in MFP 1 executing a program stored in storage unit 13 to allow each of the functions shown in FIGS. 2 and 3 to be exhibited. FIGS. 5A-5E are drawings each of which shows a practical example of a screen where operating panel 17 is displayed during the process.

With reference to FIG. 4, if login is successfully completed based on login information input to a login processing unit not shown in MFP 1 (step S101), a screen shown in FIG. 5A is displayed as an initial screen. By using this screen, a user can select a function to be used in MFP 1. When the screen in FIG. 5A is to be displayed, it is preferable that CPU 11 refers to permitted function information in user information of the logged-in user, draws a screen to display functions the relevant user is permitted to use in a selectable manner (or functions the relevant user is not permitted to use in a non-selectable manner), and allows operating panel 17 to display the functions.

If an option “CREATE AUTHENTICATION KEY” is selected on the screen in FIG. 5A (YES in step S103), CPU 11 in MFP 1 refers to permitted function information, draws a list of functions (applications) the relevant user is permitted to use in MFP 1 as shown in FIG. 5B for display in a selectable manner, allows operating panel 17 to display the list, and accepts selection of a function to be used from the user (step S105). Furthermore, CPU 11 draws a screen representing a message indicating that medium 3 identified as external memory should be mounted on MFP 1 as shown in FIG. 5C for display, and allows operating panel 17 to display the screen (step S107).

If CPU 11 detects that medium 3 is mounted on MFP 1 (YES in step S109), calculation unit 123 calculates a hash value from the file information and the directory information read from medium 3 by read unit 121 (step S111). If CPU 11 does not detect that that medium 3 is mounted (NO in step S109), CPU 11 draws a screen representing a warning to mount medium 3 on MFP 1 for display, and allows operating panel 17 to display the screen (step S113). The calculated hash value is retained in retaining unit 125 in association with the user information.

Furthermore, encrypting unit 129 encrypts a user name of the relevant user and function-to-be-used information obtained by accepting selection of a function to be used in step S105, with the use of the public key, to create an authentication key (step S115). At that time, CPU 11 monitors at prescribed intervals a degree of completion of the encryption performed by encrypting unit 129, calculates the rate thereof, draws a screen representing a degree of creation of the authentication key as shown in FIG. 5D for display, and allows operating panel 17 to display the screen.

The created authentication key is written by write unit 113 to medium 3, along with the network information of MFP 1, such as an IP address or the like of MFP 1, stored in the prescribed region in storage unit 13 (step S117). When the creation of the authentication key as such is completed, CPU 11 draws a screen indicating that the creation of the authentication key is completed and that medium 3 can be removed as shown in FIG. 5E for display, and allows operating panel 17 to display the screen. Subsequently, if another function is selected for use, a process corresponding to the function is executed (step S1119), and the processes after step S103 are repeated until log out of the relevant user is detected. If the user is logged out (YES in step S121), a series of processes terminates, and returns to a login screen display.

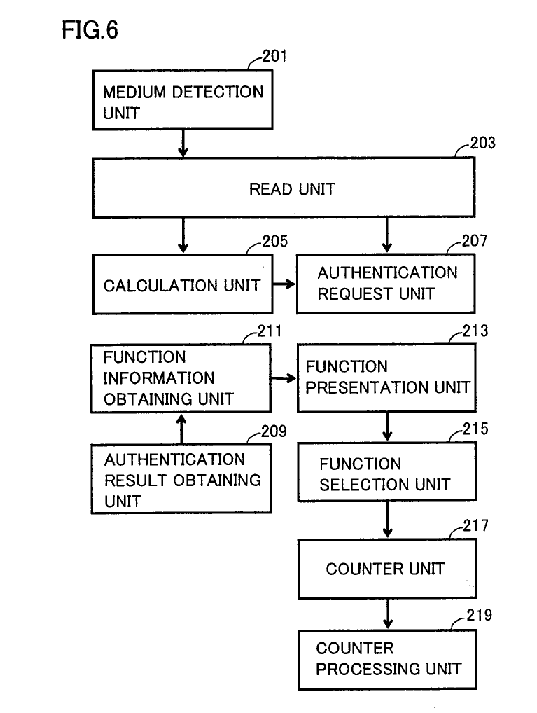

With reference to FIG. 6, functions of MFP 2 for managing a user's usage of an MFP are configured to include a medium detection unit 201, a read unit 203, a calculation unit 205, an authentication request unit 207, an authentication result obtaining unit 209, a function information obtaining unit 211, a function presentation unit 213, a function selection unit 215, a counter unit 217, and a counter processing unit 219. Each of the functions shown in FIG. 6 is implemented mainly by CPU 11 in MFP 2 executing a program stored in storage unit 13. However, a part of the functions may be configured with hardware.

Medium detection unit 201 detects that medium 3 is mounted on MFP 2, and outputs a detection signal to read unit 203. In accordance with the detection signal, read unit 203 reads from medium 3 the network information of MFP 1 and the authentication key stored in medium 3 through the above-described processes in MFP 1, and the file information and the directory information of medium 3. The file information and the directory information of medium 3 are input to calculation unit 205, and calculation unit 205 in turn calculates a hash value from these pieces of information. The network information of MFP 1 and the authentication key are input to authentication request unit 207. The hash value calculated by calculation unit 205 is also input to authentication request unit 207.

Authentication request unit 207 gains access to MFP 1 based on the input network information of MFP 1, transmits to MFP 1 the input authentication key and hash value as authentication information, and requests authentication from MFP 1.

Authentication result obtaining unit 209 obtains an authentication result from MFP 1. Function information obtaining unit 211 obtains, from the authentication result, permitted function information of the relevant user and the function-to-be-used information indicating a function selected in step S105, and inputs these pieces of information to function presentation unit 213. Based on the permitted function information and the function-to-be-used information, which have been input, function presentation unit 213 generates a signal for executing a process for allowing operating panel 17 to display available functions, and displaying the functions. Function selection unit 215 receives an operation signal from operating panel 17 based on a user operation in accordance with the screen, and accepts selection of a function to be used. Counter unit 217 counts a usage amount of the function, and counter processing unit 219 executes a process based on the count in counter unit 217, as described below. The usage amount counted by counter unit 217 corresponds to, for example, a number of printed sheets in the case where the selected function is a print function or a copy function, and corresponds to a number of transmission destinations in the case where the selected function is a data transmission function.

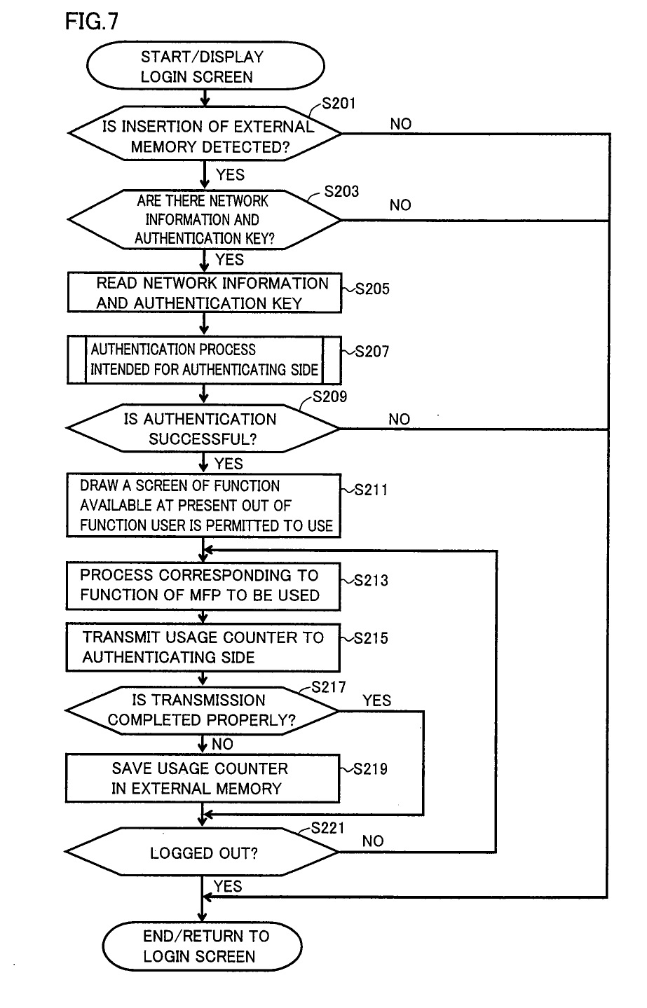

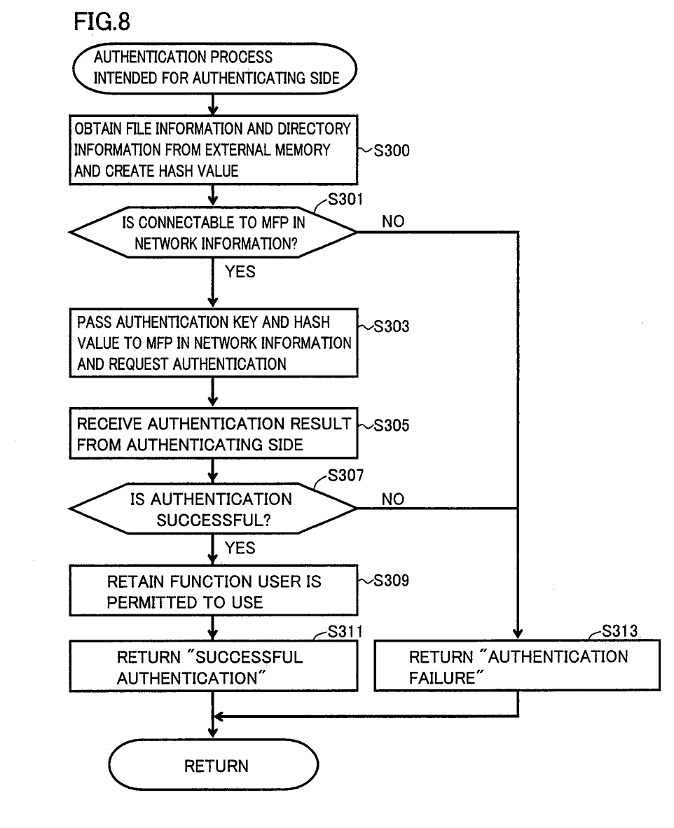

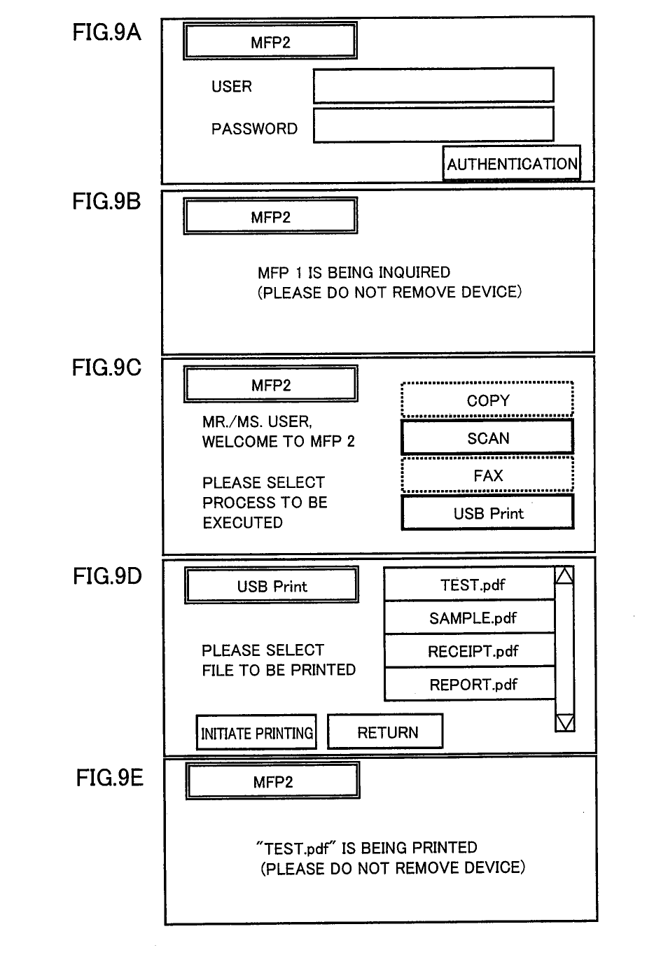

Each of FIGS. 7 and 8 shows a flowchart showing a process of managing a user's usage of an MFP in MFP2. The process shown in the flowchart in each of FIGS. 7 and 8 is the one initiated in the state where a login screen obtained when MFP 2 is turned on, for example, is displayed. The process is implemented by CPU 11 executing a program stored in storage unit 13 to allow each of the functions shown in FIG. 6 to be exhibited. Furthermore, each of FIGS. 9A-9E shows a practical example of a screen where operating panel 17 is displayed during the process.

With reference to FIG. 7, in the state where a login screen shown in FIG. 9A is displayed, a login process is executed through acceptance of user information such as a user name or a password, so that login is completed. Subsequently, medium detection unit 201 detects that a user has mounted medium 3 on MFP 2 (YES in step S201). If the mounted medium 3 stores the network information of MFP 1 and the authentication key (YES in step S203), read unit 203 reads from medium 3 the network information of MFP 1 and the authentication key (step S205). Authentication request unit 207 then executes an authentication process intended for MFP 1 identified as an authenticating side, in which authentication is requested for the authenticating side (step S207). It is preferable that a screen indicating that the authentication is under way as shown in FIG. 9B is displayed until the reception of an authentication result from MFP 1, during step S207 in which authentication is requested and MFP 1 identified as the authenticating side executes the authentication process. In the practical example, a process of requesting authentication from MFP 1 is initiated when it is detected that medium 3 is mounted on MFP 2. However, the above-described process may be initiated when it is detected that an operation for requesting authentication is made on operating panel 17, instead of, or in addition to, the fact that mounting of medium 3 is detected.

As a result of the process in step S207, if authentication is successfully completed in MFP 1 (YES in step S209), an authentication result including permitted function information of a user who has been registered with MFP 1 and intends to use medium 3 in MFP 2, and the function-to-be-used information indicating the function selected in step S1105, is obtained from MFP 1 identified as the authenticating side in the authentication process, which will be described below. Accordingly, as shown in FIG. 9C, function presentation unit 213 executes a process of drawing a screen for displaying on operating panel 17 a function to be used in the function-to-be-used information, out of the functions the relevant user is permitted to use in MFP 1, as a function available to the relevant user at present (step S211). In FIG. 9C, a scan function and a USB print function are displayed as functions available to the relevant user, in a display form different from that used for a copy function and a facsimile function which are made unavailable.

When function selection unit 215 accepts selection out of the available functions, a process corresponding to the function is executed (step S213). For example, if the USB print function is selected on the screen in FIG. 9C as a function to be used, there is executed in step S213 a process in which CPU 11 reads a file stored in medium 3 and allows operating panel 17 to display a screen that presents pieces of data to be subjected to USB printing in a selectable manner as shown in FIG. 9D. When a file to be processed is selected out of the presented files, a process of printing the file is executed. At that time, CPU 11 executes a process of allowing operating panel 17 to display a screen indicating that the selected file is being printed, as shown in FIG. 9E. Furthermore, counter unit 217 counts a usage amount of the function (a number of printed sheets in the practical example).

When use of the function is completed, counter processing unit 219 executes a process for transmitting a usage counter identified as the usage amount counted by counter unit 217 to MFP 1 serving as an authenticating side (step S215). If the transmission is not successfully completed (NO in step S217), counter processing unit 219 saves the usage counter in medium 3 (step S219).

The processes in steps S213-S219 are repeated until log out of the relevant user is detected. When the log out is detected (YES in step S221), a series of processes is terminated and returns to a login screen display. If mounting of medium 3 is not detected in step S201 (NO in step S201), if mounted medium 3 fails to store network information of MFP 1 and an authentication key in step S203 (NO in step S203), or if a response indicating authentication failure is received from MFP 1 serving as an authenticating side in response to the authentication request in the authentication process in step S207 (NO in step S209), a series of processes is also terminated without executing subsequent processes.

FIG. 8 is a flowchart showing a practical example of the authentication process in step S207 in which MFP 2 requests an authentication process from MFP 1 serving as a transmission destination and receives a result thereof.

With reference to FIG. 8, initially, calculation unit 205 reads file information and directory information from medium 3 and calculates a hash value (step S300). If authentication request unit 207 connects to the network information read from medium 3 in step S205 and successfully gains access to MFP 1 (YES in S301), authentication request unit 207 transmits to MFP 1 the authentication key read in step S205 and the hash value calculated in step S300 as authentication information, along with a signal requesting authentication, and requests authentication (step S303).

Subsequently, if an authentication result received in step S305 from MFP 1 serving as an authenticating side is a result indicating successful authentication (YES in step S307), function information obtaining unit 211 obtains the relevant user's permitted function information and function-to-be-used information in MFP 1 included in the authentication result, and retains the same (step S309). Then “successful authentication” is returned to a main routine as an authentication result (step S311). In contrast, if the authentication result received in step S305 from MFP 1 serving as an authenticating side is a result not indicating successful authentication (NO in step S307), “authentication failure” is returned to the main routine as an authentication result (step S313).

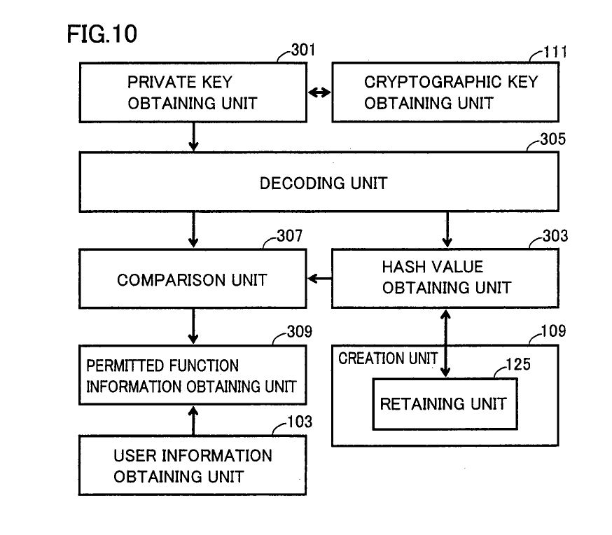

FIG. 10 is a functional configuration of MFP 1 for executing an authentication process in response to a request by MFP 2, in the form of a block diagram showing a detailed practical example of a configuration included in authentication unit 117.

With reference to FIG. 10, authentication unit 117 is configured to include a private key obtaining unit 301, a hash value obtaining unit 303, a decoding unit 305, a comparison unit 307, and a permitted function information obtaining unit 309.

Private key obtaining unit 301 obtains a private key from cryptographic key storage unit 111 and passes it to decoding unit 305. Decoding unit 305 uses the private key to decode the authentication key included in the authentication information from MFP 2, which has been obtained by authentication information obtaining unit 115. A user name obtained by decoding the authentication key is input to hash value obtaining unit 303.

Hash value obtaining unit 303 obtains from retaining unit 125 a hash value retained in association with the input user name, and inputs it to comparison unit 307. Comparison unit 307 compares the input hash value and the hash value included in the authentication information transmitted from MFP 2, which has been obtained by authentication information obtaining unit 115.

If both of the hash values match with each other as a result of the comparison by comparison unit 307, permitted function information obtaining unit 309 obtains permitted function information of the relevant user from the user information of the relevant user obtained by user information obtaining unit 103 from user information storage unit 105, as “successful authentication”. If the authentication is successfully completed, output unit 119 transmits permitted function information of the relevant user and function-to-be-used information obtained by decoding the authentication key, along with the authentication result indicating “successful authentication”, to MFP 2, which has requested the authentication.

If both of the hash values fail to match with each other as a result of the comparison by comparison unit 307, output unit 119 transmits an authentication result indicating “authentication failure” to MFP 2.

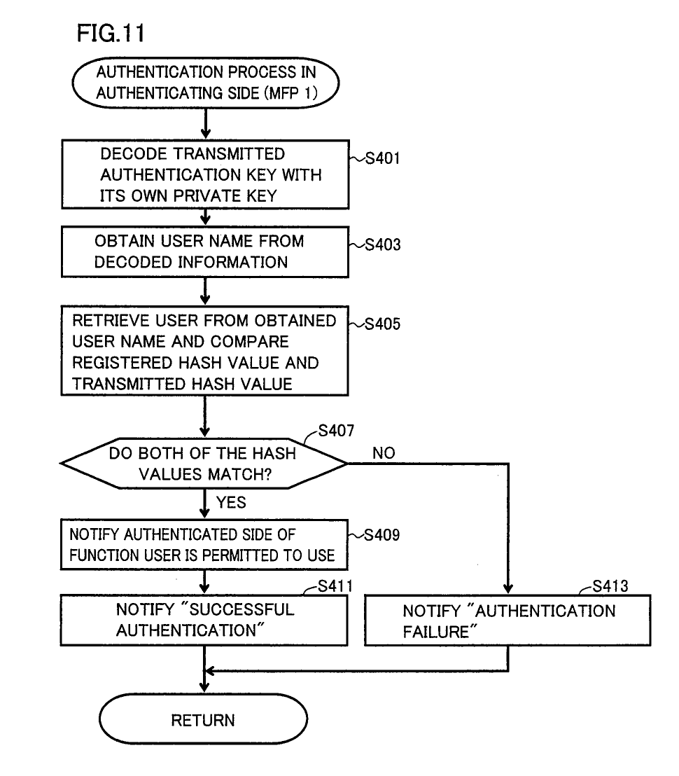

FIG. 11 is a flowchart showing a practical example of an authentication process in MFP 1. The process shown in the flowchart in FIG. 11 is the one initiated when authentication information and a signal requesting authentication, which have been transmitted from MFP 2 in step S303, are received. The process is implemented by CPU 11 in MFP 1 executing a program stored in storage unit 13 to allow each of the functions shown in FIGS. 2, 3 and 10 to be exhibited.

With reference to FIG. 11, initially, decoding unit 305 decodes the authentication key, which is included in the authentication information transmitted in step S303, by using the private key obtained by private key obtaining unit 301 (step S401), and obtains a user name (step S403). Hash value obtaining unit 303 obtains from retaining unit 125 a hash value retained in MFP 1 in association with the user name obtained by decoding the authentication key in step S403. Comparison unit 307 compares the hash value obtained within MFP 1 and the hash value included in the authentication information transmitted from MFP 2 in step S303 (step S405).

If both of the hash values match with each other as a result of the comparison in step S405 (YES in step S407), permitted function information obtaining unit 309 obtains permitted function information from the user information of the relevant user obtained by user information obtaining unit 103. Output unit 119 notifies MFP 2, which serves as an authenticated side requesting authentication, of the permitted function information obtained, along with the function-to-be-used information obtained by decoding the authentication key in step S405 (step S409). Furthermore, output unit 119 also notifies MFP 2 of an authentication result indicating “successful authentication” (step S411).

If these hash values fail to match with each other as a result of the comparison in step S405 (NO in step S407), output unit 119 notifies MFP 2 of an authentication result indicating “authentication failure” (step S413).

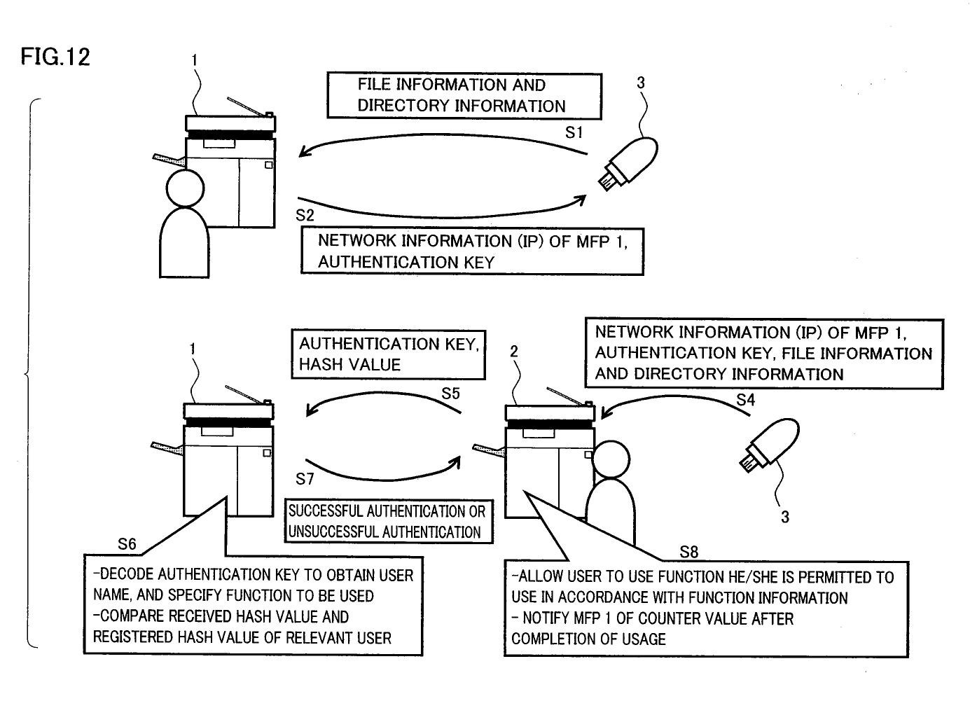

By executing the above-described processes in MFP 1 and MFP 2 according to the present embodiment, a user's usage of an MFP on which medium 3 is mounted is managed in MFP 1 and MFP 2, as shown in FIG. 12.

If a user intends to use MFP 2 with which the user is not registered, medium 3 is mounted on MFP 1 with which the user is registered, to instruct MFP 1 to create an authentication key.

With reference to an upper drawing in FIG. 12, when MFP 1 accepts the instruction above and creates an authentication key, the process in step S111 is executed so that file information and directory information are read to MFP 1 from medium 3 mounted on MFP 1 (step S1). The processes in steps S111 and S115 are executed in MFP 1 so that a hash value is calculated from the file information and the directory information. The calculated hash value, the user name, and the function-to-be-used information indicating a function selected as the one to be used in MFP 2 are encrypted with the use of a public key, so that an authentication key is created. In the process in step S117, the created authentication key and the network information of MFP 1 are written to medium 3 (step S2). Furthermore, the calculated hash value is retained in MFP 1 in association with the user name.

The user removes medium 3 from MFP 1 and mounted the same on MFP 2 with which the user is not registered, so that the authentication process is executed.

With reference to a lower drawing in FIG. 12, when mounting of medium 3 is detected in MFP 2 in step S201 and the authentication process is executed, the process in step S205 is executed, so that the network information, the authentication key, and the file information and the directory information are read from medium 3 mounted on MFP 2 (step S4). The process in step S207 is executed in MFP 2. With the process in step S207, MFP 2 gains access to MFP 1 based on the network information read from medium 3, transmits to MFP 1 the authentication key read from medium 3 and a hash value calculated from the file information and the directory information in step S300, as authentication information, and requests authentication (step S5).

In the present embodiment, the authentication key identified as data encrypted as authentication information and read from medium 3, is transmitted from MFP 2 to MFP 1 without being decoded in MFP 2. In other words, the user name, the function-to-be-used information, and the like are not transmitted on the network without being encrypted. Accordingly, it is possible to more effectively prevent leakage of information such as a user name or function-to-be-used information, when compared with a process of decoding the authentication key in MFP 2 and transmitting the user name or the like to MFP 1 for requesting authentication.

In MFP 1, from which authentication is requested, the processes in steps S401 and S403 are executed, so that the authentication key is decoded and a user name is obtained, and there is made a comparison between the hash value retained in MFP 1 in association with the user name obtained in step S405 and the hash value transmitted from MFP 2 (step S6). Consequently, an authentication result indicating “successful authentication” is transmitted to MFP 2 in step S411 if both of the hash values match with each other, or an authentication result indicating “authentication failure” is transmitted to MFP 2 in step S413 if both of the hash values fail to match with each other (step S7). Furthermore, in the case of “successful authentication”, permitted function information of the relevant user is obtained from the user name obtained by decoding the authentication key, and transmitted to MFP 2 along with the authentication result.

If the authentication result in MFP 1 is “successful authentication”, the process in step S211 is executed in MFP 2. Based on the function-to-be-used information and the permitted function information of the relevant user transmitted along with the authentication result, an available function is presented and the user is permitted to use the function (step S8). Accordingly, if the user intends to use MFP 2 with which the user is not registered, he/she is only required to perform an operation of mounting on MFP 2 medium 3 storing an authentication key created in advance, and is not required to perform a complicated operation for registering himself/herself with MFP 2.

In MFP 2, the process in step S215 is further executed, so that when a selected function is used, a usage amount thereof is counted and MFP 1 is notified of a usage counter (step S8). At that time, if transmission to MFP 1 is not successfully completed, the step in step S219 is executed so that the usage counter is written to medium 3 mounted on MFP 2. By allowing MFP 1, with which the relevant user is registered, to be notified of a usage counter, the relevant user's usage of an MFP can be managed in MFP 1, while usage in MFP 2 is also considered. Specifically, it is possible in MFP 1 to store the received usage counter in MFP 2, in addition to the usage counter in MFP 1, which has already been stored as user information. Furthermore, if the transmission above is not successfully completed, medium 3 stores the usage counter. Accordingly, if the relevant user uses medium 3 in MFP 1, MFP 1 obtains the usage counter in MFP 2 from medium 3 so that it is possible to manage the relevant user's usage of an MFP as in the case where the usage counter is transmitted from MFP 2.

Furthermore, it is also possible to provide a program allowing a computer to execute the processes for implementing a method of creating an authentication key in MFP 1, a method of managing usage and a usage amount in MFP 2, and an authentication method in MFP 1, as described above. Such a program may also be provided as a program product in which the program is recorded in a computer readable recording medium such as a flexible disk, Compact Disk-Read Only Memory (CD-ROM), Read Only Memory (ROM), RAM, or a memory card attached to the computer. Alternatively, the program may also be provided by being recorded in a recording medium such as a hard disk embedded in the computer. Alternatively, the program may also be provided by being downloaded through a network.

The program according to the present invention may be the one invoking a necessary module in a prescribed order and at prescribed timing, out of program modules provided as a part of an operation system (OS) of the computer, and allowing the necessary module to execute a process. In that case, the program itself does not include the above-described module, and the program cooperates with the OS to execute a process. Such a program that does not include a module can also be included in the program according to the present invention.

Alternatively, the program according to the present invention may be provided by being incorporated in a part of another program. In that case, the program itself does not include a module included in other program above, and the program cooperates with other program to execute a process. Such a program incorporated in another program can also be included in the program according to the present invention.

The program product to be provided is installed in a program storage unit such as a hard disk for execution. The program product includes a program itself and a recording medium that records the program.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image forming apparatus, comprising:
a user information obtaining unit obtaining user information of a user logging into said image forming apparatus;
a retaining unit retaining information specific to a mounted medium in association with said user information;
a creation unit creating a first authentication key by encrypting said user information;
a write unit writing to said medium said first authentication key and information for specifying said image forming apparatus;
an authentication information obtaining unit obtaining authentication information from another image forming apparatus;
a decode unit decoding a second authentication key included in said authentication information;
a comparison unit making comparison, based on user information obtained by decoding said second authentication key, between the information specific to said medium and retained by said retaining unit in association with said user information obtained by decoding said second authentication key, and information specific to a medium and included in said authentication information; and
an output unit outputting a result of said comparison to said other image forming apparatus.

2. The image forming apparatus according to claim 1, further comprising
a read unit reading at least one of file information identified as information relating to a file stored in said medium, and directory information identified as information indicating a directory configuration, and
a calculation unit calculating a hash value of at least one of said file information and said directory information, wherein
the information specific to said mounted medium is said hash value.

3. The image forming apparatus according to claim 1, wherein the information specific to said mounted medium is a serial number of said medium.

4. The image forming apparatus according to claim 1, wherein the information for specifying said image forming apparatus is information for gaining access to said image forming apparatus.

5. The image forming apparatus according to claim 1, wherein
said user information obtained by said user information obtaining unit includes limiting information of said user for limiting usage of a function provided at said image forming apparatus, and
said output unit transmits said limiting information of said user along with the result of said comparison, in accordance with the result of said comparison.

6. The image forming apparatus according to claim 1, further comprising an accepting unit accepting selection of a function to be used in said other image forming apparatus, wherein said creation unit encrypts function-to-be-used information identified as information indicating said function accepted by said accepting unit and said user information obtained by said user information obtaining unit, to thereby create said first authentication key.

7. The image forming apparatus according to claim 1, wherein
said second authentication key includes function-to-be-used information identified as information indicating a function to be used in said other image forming apparatus, and
said output unit transmits said function-to-be-used information obtained by decoding said second authentication key along with the result of said comparison, in accordance with the result of said comparison.

8. An image forming apparatus, comprising:
a read unit reading information for specifying another image forming apparatus and an authentication key from a mounted medium;
a request unit requesting authentication from said other image forming apparatus by transmitting thereto information specific to said medium and said authentication key, as authentication information;
an authentication result obtaining unit obtaining a result of said authentication from said other image forming apparatus; and
a presentation unit presenting a specific function in a selectable manner, based on information included in the result of said authentication.

9. The image forming apparatus according to claim 8, wherein
said read unit reads at least one of file information identified as information relating to a file stored in said medium, and directory information identified as information indicating a directory configuration,
the image forming apparatus further comprises a calculation unit calculating a hash value of at least one of said file information and said directory information, and
the information specific to said medium is said hash value.

10. The image forming apparatus according to claim 8, wherein the information specific to said medium is a serial number of said medium.

11. The image forming apparatus according to claim 8, wherein
the information included in the result of said authentication includes limiting information of a user specified by said authentication key for limiting usage of a function provided at said other image forming apparatus, and function-to-be-used information identified as information indicating a function to be used in said image forming apparatus specified by said authentication key, and
said presentation unit presents the function to be used in said image forming apparatus in a selectable manner as said specific function, out of functions said user is permitted to use in said other image forming apparatus.

12. The image forming apparatus according to claim 8, further comprising
a selection unit selecting a function to be used out of said specific function,
a count unit counting a usage amount of said function selected by said selection unit, and
a counter processing unit executing a process for outputting said usage amount.

13. The image forming apparatus according to claim 12, wherein said counter processing unit executes a process for transmitting said usage amount to said other image forming apparatus, or a process for writing said usage amount to said medium.

14. A method of managing usage and a usage amount in each of image forming apparatuses is a method of managing usage and a usage amount by a user in each of a first image forming apparatus and a second image forming apparatus, comprising the steps of:
obtaining user information of said user logging into said first image forming apparatus, in said first image forming apparatus;
retaining information specific to a medium mounted on said first image forming apparatus, in said first image forming apparatus in association with said user information;
creating an authentication key by encrypting said user information in said first image forming apparatus;
writing said authentication key and information for specifying said first image forming apparatus to said medium in said first image forming apparatus;
reading said authentication key and the information for specifying said first image forming apparatus from said medium mounted on said second image forming apparatus, in said second image forming apparatus;
requesting authentication from said first image forming apparatus by transmitting thereto the information specific to said medium mounted on said second image forming apparatus and said authentication key, as authentication information, in said second image forming apparatus;
decoding said authentication key transmitted from said second image forming apparatus, in said first image forming apparatus;
making a comparison in said first image forming apparatus, based on user information obtained by decoding said authentication key, between the information specific to said medium and retained in association with said user information obtained by decoding said authentication key, and information specific to the medium and included in said authentication information;
outputting a result of said comparison as a result of said authentication from said first image forming apparatus to said second image forming apparatus; and
presenting a specific function in a selectable manner in said second image forming apparatus, based on information included in the result of said authentication from said first image forming apparatus.

15. A computer readable recording medium recording a management program, wherein
said management program is a program for allowing a computer to manage usage and a usage amount by a user in each of a first image forming apparatus and a second image forming apparatus, and allows said computer to execute the steps of:
obtaining user information of said user logging into said first image forming apparatus, in said first image forming apparatus;
retaining information specific to a medium mounted on said first image forming apparatus, in said first image forming apparatus in association with said user information;
creating an authentication key by encrypting said user information in said first image forming apparatus;
writing said authentication key and information for specifying said first image forming apparatus to said medium in said first image forming apparatus;
reading said authentication key and the information for specifying said first image forming apparatus from said medium mounted on said second image forming apparatus, in said second image forming apparatus;
requesting authentication from said first image forming apparatus by transmitting thereto the information specific to said medium mounted on said second image forming apparatus and said authentication key, as authentication information, in said second image forming apparatus;
decoding said authentication key transmitted from said second image forming apparatus, in said first image forming apparatus;
making a comparison in said first image forming apparatus, based on user information obtained by decoding said authentication key, between the information specific to said medium and retained in association with said user information obtained by decoding said authentication key, and information specific to the medium and included in said authentication information;
outputting a result of said comparison as a result of said authentication from said first image forming apparatus to said second image forming apparatus; and
presenting a specific function in a selectable manner in said second image forming apparatus, based on information included in the result of said authentication from said first image forming apparatus.
